(19) United States
(12) Patent Application Publication
(10) Pub. No.: US 2022/0295805 A1
(43) Pub. Date: Sep. 22, 2022

(54) Chocolate Rum Nut Cake

(71) Applicant: Stephanie Friede, New York, NY (US)

(72) Inventor: Salcha Pressner, (deceased) (US)

(21) Appl. No.: 17/207,831

(22) Filed: Mar. 22, 2021

(51) Int. Cl. A21D 13/80; A21D 2/26; A21D 2/18; A21D 2/36; A21D 10/04; A23G 1/50

(52) U.S. Cl. CPC A21D 13/80; A21D 2/262; A21D 2/186; A21D 2/364; A21D 2/181; A21D 10/04; A23G 1/50

(57) ABSTRACT

The present invention is a recipe for a unique flourless and gluten-free walnut rum cake. It is made of ground walnuts, confectioner's sugar, melted chocolate, lemon juice and twelve eggs. The frosting layer is made of twelve ounces of confectioner's sugar, six ounces of unsalted chocolate, eight ounces of unsalted butter, and a half cup of dark rum.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### CROSS REFERENCE TO RELATED APPLICATION

Not applicable.

### FIELD

The present invention relates to the field of chocolate rum cakes.

### BACKGROUND OF THE INVENTION

Cakes are a form of sweet baked good that are usually made from flour, sugar, and other ingredients, such as fruit or chocolate.

There are two main categories of types of cake, butter (or shortened)and foam. The main difference between them is usually the content of fat. Butter cakes utilize butter, oil, or shortening. Foam cakes have little to no fat, but utilize whipped eggs (white, yolks, or both).

Examples of butter cakes include the classic yellow cake, yellow butter cakes, pound cakes, red velvet cakes, carrot cakes, upside down cake, devil's food cake, hummingbird cake,

Examples of foam cakes include sponge cakes, genoise cakes, angel food cake,

Hybrids between foam and butter cakes include chiffon cakes.

Most cakes employ flour. The use of flour makes these cakes unsuitable for use during

Jewish holidays and for those with wheat allergies.

The foregoing prior art does not describe the present invention.

The current invention provides numerous advantages over the prior art. This includes a flourless cake which is suitable for Jewish holidays and is gluten-free.

### SUMMARY OF THE INVENTION

The product made by the process comprising:

An oven is heated;

Twelve eggs are separated into twelve whites and twelve yolks;

A pound of walnuts is ground;

One pound of confectioner's sugar, said twelve yolks, eight ounces of melted unsweetened chocolate, and two tablespoons of lemon juice are blended together to create a chocolate mixture;

Said twelve whites are whipped into stiff peaks;

Said chocolate mixture is folded into said egg whites to create a mixture of chocolate and egg whites;

Said pound of walnuts are folded into said mixture of chocolate and egg whites and poured into a spring-form pan to create a raw cake mixture;

Said raw cake mixture is placed in said oven for approximately 40 minutes to create a baked walnut cake;

Twelve ounces of confectioner's sugar, six ounces of unsalted chocolate, eight ounces of unsalted butter; and a half cup of dark rum are blended together to create a frosting mixture; and

Said frosting mixture is spread on said baked walnut cake.

The oven of [0012] wherein it is heated to approximately 350 degrees Fahrenheit.

The spring-form pan of [0012] wherein it is a 12″ pan.

The spring-form pan of [0014] wherein it is coated with butter and bread-crumbs.

The spring-form pan of [0012] wherein it is a 9″ pan.

The spring-form pan of [0016] wherein it is coated with butter and bread-crumbs.

A cake comprising ground walnuts, confectioner's sugar, twelve eggs, melted chocolate, and lemon juice.

### DETAILED DESCRIPTION OF THE PREFERRED EMBODIMENTS

For a more complete understanding of the present invention, the objects and advantages thereof, reference is now made to the ensuing descriptions.

The present invention is a flourless, chocolate rum nut cake.

The present invention utilizes the following ingredients for the creation of the cake:

(1) A dozen large eggs; (2) One pound of confectioner's sugar; (3) Eight ounces of melted unsweetened chocolate; (4) One pound of walnuts; and, (5) Two tablespoons of lemon juice.

The present invention utilizes the following ingredients for the frosting of the cake: (1) Twelve ounces of confectioner's sugar; (2) Six ounces of unsalted chocolate; (3) Eight ounces of unsalted butter; and (4) a half cup of dark rum.

The present invention also utilizes an oven, butter, bread crumbs and either a single 12″ spring-form pan or two 9″ spring-form pans.

In a preferred embodiment, the chocolate is melted. In a preferred embodiment, the use of baker's pro-melted chocolate is discouraged.

In a preferred embodiment, the eggs are warmed to room temperature and separated into yolks and whites.

In a preferred embodiment, the cake is made with the following steps:

In a first step, the oven is preheated to 350 degrees Fahrenheit.

In a second step, the 12″ spring-form pan or the two 9″ spring-form pan is butter and coated with bread crumbs.

In a third step, the confectioner's sugar, egg yolks, melted chocolate, and lemon juice are blended together to create a chocolate mixture.

In a fourth step, the eggs whites are whipped into stiff peaks.

In a fifth step, the chocolate mixture is folded into the egg whites using a very large spoon.

In a sixth step, the walnuts are gradually folded into the mixture of chocolate and egg whites and this mixture is poured into the 12″ spring-form pan or the two 9″ spring-form pans, which were buttered and coated in step two.

In a seventh step, the mixture of step six is baked for 40 minutes in the oven that was preheated in step one.

In an eighth step, the oven of step seven is turned off and the mixture remains in the oven with the door closed for twenty minutes.

In a ninth step, a sharp knife is inserted into the cake. If the knife is removed without any portions of the cake on the knife, then the cake is finished baking. If a portion of the cake remains on the knife, then the cake remains in the cooling oven for another ten minutes, or until a knife, subsequently inserted into the cake, is removed without any portion of the cake on the knife.

In a tenth step, the ingredients of the frosting are blended together until smooth.

In an eleventh step, the cake is sprinkled with rum.

In a twelfth, the 12″ cake is sliced in half and frosted with the smooth ingredients from the tenth step.

In a thirteenth step, the frosted cake from step twelve is sprinkled with grated walnuts.

In a fourteenth step, the frosted cake of step thirteen is decorated with walnut halves.

I claim

1. The product made by the process comprising:
An oven is heated;
Twelve eggs are separated into twelve whites and twelve yolks;
A pound of walnuts is ground;
One pound of confectioner's sugar, said twelve yolks, eight ounces of melted unsweetened chocolate, and two tablespoons of lemon juice are blended together to create a chocolate mixture;
Said twelve whites are whipped into stiff peaks;
Said chocolate mixture is folded into said egg whites to create a mixture of chocolate and egg whites;
Said pound of walnuts are folded into said mixture of chocolate and egg whites and poured into a spring-form pan to create a raw cake mixture;
Said raw cake mixture is placed in said oven for approximately 40 minutes to create a baked walnut cake;
Twelve ounces of confectioner's sugar, six ounces of unsalted chocolate, eight ounces of unsalted butter; and a half cup of dark rum are blended together to create a frosting mixture; and
Said frosting mixture is spread on said baked walnut cake.

2. The oven of claim 1 wherein it is heated to approximately 350 degrees Fahrenheit.

3. The spring-form pan of claim 1 wherein it is a 12″ pan.

4. The spring-form pan of claim 3 wherein it is coated with butter and bread-crumbs.

5. The spring-form pan of claim 1 wherein it is a 9″ pan.

6. The spring-form pan of claim 5 wherein it is coated with butter and bread-crumbs.

7. A cake comprising ground walnuts, confectioner's sugar, twelve eggs, melted chocolate, and lemon juice.
